(19) United States
(12) Patent Application Publication
(10) Pub. No.: US 2005/0040918 A1
(43) Pub. Date: Feb. 24, 2005

(54) Strip-loaded dielectric substrates for improvements of antennas and microwave devices

(76) Inventor: Per-Simon Kildal, Pixbo (SE)

Correspondence Address: HARNESS, DICKEY & PIERCE, P.L.C., P.O. BOX 8910, RESTON, VA, 20195, US

(21) Appl. No.: 10/495,330

(22) PCT Filed: Nov. 12, 2002
(86) PCT No.: PCT/SE02/02066

(30) Foreign Application Priority Data
Nov. 12, 2001 (SE) 0103783-7

(51) Int. Cl. H01P 3/12

(52) U.S. Cl. 333/239

(57) ABSTRACT

In the invention strip-loaded dielectric substrates are used as amean to improve or construct new types of antennas or microwave devices. The strips are made of metal, and they are provided with periodic elements that prohibits quasi-TEM waves from being guided between the strips and the groundplane on the opposite side of the substrate, and surface waves from propagating in the substrate. Examples of such elements are: shorting pins, also called via holes or simply vias, between the strips and the ground plane; removed pieces of the strips, so that they actually look like long rectangular patches rather than strips; short pieces of the strips with a different strip width; other parasitic elements in direct contact with the strips or near them.

### BACKGROUND

In recent years much interest has been directed to soft and hard surfaces and how they can be used to improve antennas and microwave devices. Such soft and hard surfaces can be realized in several ways, e.g. by corrugations in a metal surface, or by a grounded dielectric substrate that is loaded by metal strips.

The last years other parts of the electromagnetic society have shown a great interest in the search for periodic material structures or surfaces that can be used to improve antennas and microwave devices. Such materials or structures are often referred to as photonic bandgap structures or surfaces, and the acronym PBG is often used.

Until recently it has not been much interaction between researchers working with soft and hard surfaces and those working with PBG structures or surfaces, even though some applications are very similar. Such are in particular applications where the PBG surface is used as a high impedance surface and behaves like an artificial magnetic conductor (AMC).

One promising PBG working as an AMC is the high impedance surface as described in U.S. Pat. No. 6,262,495 by Dan Sievenpiper. This consists of a grounded dielectric substrate loaded with metal patches. There are metal pins or via holes providing metal contact between the center of the patch and the ground plane. Some persons refer to these surfaces as mushroom surfaces, because they look like a collection of mushrooms. Some designs without the via holes have also been reported.

In U.S. Pat. No. 5,392,152 by Aiden Higgins a device is disclosed that makes use of strips instead of patches, and where the strips are shorted periodically with metal pins or via holes towards the metal ground on the opposite side of the substrate. However, this patent is solely concerned with a specific type of active microwave device called a grid amplifier.

Such grid amplifiers are located inside waveguides, and they can provide much more output power if the waveguide is provided with hard surface walls. The strip-loaded dielectric substrate enables this. The strip-loaded soft surface is much cheaper to realize than the corrugated soft surface. However, it has much narrower bandwidth and support surface waves that destroy the performance.

The strip-loaded hard surface is also much cheaper to realize than the corrugated hard surface. However, the performance is even worse than for the soft strip-loaded surface, due to undesired quasi-TEM waves propagating along the strips with the fields located between the strips, and the ground plane (on the opposite side of the substrate).

From U.S. Pat. No. 393,677 A1 it is further known to use a metal stud or wire in order to suppress resonant modes in a metal box which contains a microstrip circuit. However, these metal studs have no similarities in structure or intended use with the present invention.

Accordingly, due to the above-discussed problems strip-loaded surfaces are at present not a feasible alternative for the construction of antennas and microwave devices.

### DESCRIPTION OF THE INVENTION

It is therefore the object of the present invention to alleviate the disadvantages and problems associated with strip-loaded grounded dielectric substrates, when these are used to generate soft or hard surfaces.

This object is achieved with an antenna and a microwave device as defined in the appended claims.

The invention relates to an antenna or a microwave device, comprising a grounded dielectric substrate and a plurality of metal strips arranged on said substrate. Further, it comprises restraining elements adapted to prohibit at least one predetermined type of waves from propagating along the strips.

Hereby, the inherent advantages of using strips in this context could be fully exploited, without the problems due to unwanted wave propagation, as experienced in the prior art. Especially, the restraining elements could be adapted to prohibit quasi-TEM waves from propagating along the strips and/or surface waves from propagating in the dielectric substrate. In a preferred embodiment, the device further comprises a ground plane arranged on the side of the dielectric substrate being opposite to the strips, wherein said restraining elements are adapted to prohibit waves from propagating along the strips between the strips and the ground plane.

Several different restraining elements could be used, either in the alternative or in different combinations. For example, the restraining elements could comprise shorting connections, such as shorting pins or via holes, between the strips and a ground plane. Further, the restraining elements could comprise parts of the strips having dimensional deviations. Such dimensional deviations could comprise a decreased dimension, such as indentations, recesses, cavities, cut-in portions or openings, or an increased dimension, such as an increased width or thickness over a part of the strips. The restraining elements could also comprise other parasitic elements arranged in the vicinity of the strips. The type of restraining elements to be used is preferably chosen in dependence of the types of waves to be prohibited, the characteristics of the antenna/microwave device, quality and cost aspects, etc.

The strips could be arranged in different fashions. According to one line of embodiments, the strips are arranged in essentially straight, and preferably parallel, lines. Alternatively, the strips could be arranged in lines forming closed loops, and preferably circles, and most preferably essentially concentric circles. It is further preferred that the strips are so dimensioned and so closely arranged that the strip width together with the distance between adjacent strips does not exceed a typical wavelength for which the antenna or microwave device is designed, and preferably not exceeding a typical half wavelength, and most preferably is significantly smaller than half the wavelength. The choice of arrangement fashion and dimensioning of the strips is preferably made in dependence of the types of waves to be prohibited, the characteristics and dimensions of the antenna/microwave device, quality and cost aspects, etc.

Further, it is preferred that the distance between restraining elements on each strip does not exceed a typical guide wavelength of the prohibited wave at the frequency for which the antenna or microwave device is designed, and preferably is about half this guide wavelength. This enables an effective prohibition of the unwanted waves.

Different embodiments of antennas according to the invention are possible. In one embodiment, the antenna is formed by an essentially plane dielectric substrate, wherein said strips are arranged on one side of said substrate. Hereby, a flat antenna is provided. Preferably, the strips are arranged to encircle a central region, said central region being provided with antenna elements.

In another embodiment, the antenna comprises a dielectric substrate forming a core, wherein said strips are arranged to at least partly enclose said substrate.

Different embodiments of microwave devices according to the invention are possible as well. According to one embodiment the dielectric substrate forms an inner waveguiding volume, wherein said strips are arranged on the inner walls facing said inner waveguiding volume. The strips could e.g. be arranged either in lines essentially following the axial direction of the waveguiding volume, or in lines essentially transversal to the axial direction of the waveguiding volume.

Accordingly, in the invention strip-loaded dielectric substrates are used as a mean to improve or construct new types of antennas or microwave devices. The strips are made of metal, and they are provided with preferably periodically arranged restraining elements that prohibits certain types of waves, such as:
1) quasi-TEM waves from being guided between the strips and the ground plane on the opposite side of the substrate, and
2) surface waves from propagating in the substrate.

Examples of possible restraining elements are:
shorting pins, also called via holes or simply vias, between the strips and the ground plane;
removed pieces of the strips, so that they actually look like long rectangular patches rather than strips;
short pieces of the strips with a different strip width;
other parasitic elements in direct contact with the strips or near them.

Preferably, the metal strips are directly connected to the restraining elements. Hereby, the metal strip-loaded wall could be an integral part of the device needed to control radiation or propagation characteristics, such as a ground plane or similar. Accordingly, the desired signal is guided by waves propagating in the region outside strip-loaded dielectric walls, or between such walls.

Further, the restraining elements, such as posts or via holes, are connected between the metal strips and the ground plane, which inhibits a signal from propagation along the microstrip line. Accordingly, the metal strips in the inventive device could be used primarily to change the boundary conditions of the field on the strip-loaded walls.

According to one embodiment, the restraining elements are connected to central areas of the metal strips. Alternatively, the restraining elements could be connected to peripheral areas of the metal strips. However, further placement alternatives are also feasible.

The microwave device may also comprising dielectric substrates arranged in at least two separate layers and metal strips arranged in at least two separate layers. E.g. two, three or four dielectric layers could be used. At least one of said metal strip layers is then preferably arranged in between the dielectric substrate layers. Most preferably, one metal strip layer is arranged between every adjacent pair of dielectric layers, as well as on top of the uppermost dielectric layer. Thus, the number of dielectric layers and strip layers are preferably the same. Further, the restraining elements are preferably adapted to prohibit at least one predetermined type of waves from propagating along at least one of the metal strip layers. Preferably, the uppermost strip layer is provided with the restraining elements, such as via holes, whereas the restraining elements on strip layers of lower levels are optional.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic illustration of different views of a substrate comprising strips arranged on one side, and with contact elements arranged to provide ground contact for the strips, according to an embodiment of the invention. In this case, no dielectric substrate between the strips and the ground plane is shown, in order to reviel the vertical contact elements between the strips and the ground plane;

FIGS. 2-6 are schematic illustratitions of strip arrangement with different types of restraining elements according to different embodiments of the invention;

FIG. 7 is a schematic illustration of a strip arrangement where the strips are arranged in circular lines;

FIG. 8 is a schematic illustration of a strip arrangement where the strips are arranged along non-parallel lines in a fan-like fashion;

FIG. 9 is a schematic illustration of strips arranged on a curved, cylindrical surface according to an embodiment of the invention, where the strips are arranged in circles in a transversal direction;

FIG. 10 is a schematic illustration of strips arranged on a curved, cylindrical surface according to an embodiment of the invention, where the strips are arranged in essentially straight lines in a longitudinal direction;

FIG. 11 is a schematic illustration of a section of a waveguide with rectangular cross-section, or a pyramidal horn antenna, according to an embodiment of the invention, where the strips are arranged in a transversal direction;

FIG. 12 is a schematic illustration of a section of a waveguide with rectangular cross-section, or a pyramidal horn antenna, according to an embodiment of the invention, where the strips are arranged in a longitudinal direction;

FIG. 13 is a schematic illustration of a section of a waveguide with circular cross-section, or a conical horn antenna, according to an embodiment of the invention, where the strips are arranged in a transversal direction;

FIG. 14 is a schematic illustration of a section of a waveguide with circular cross-section, or a conical horn antenna, according to an embodiment of the invention, where the strips are arranged in a longitudinal direction;

FIG. 15 is a schematic illustration of a flat section of an antenna according to an embodiment of the invention, where strips are arranged to enclose centrally arranged antenna elements;

FIG. 16 is a schematic illustration of a cylindrical section of an antenna according to an embodiment of the invention, where strips are arranged transversally on the outside walls; and

FIG. 17 is a schematic illustration of a cylindrical section of an antenna with a sandwich construction according to an embodiment of the invention, where strips are arranged on the top wall.

FIG. 18 is a schematic illustration of sections of two radome panels that are connected by a joint, in which the joint is an embodiment of the invention, of the type shown in FIG. 17. Thus, the so-called cylindrical sections described in 16 and 17 may very well be parts of a larger non-cylindrical section, as shown in FIG. 18.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. The geometries shown are just examples. In particular, they may be small parts of other sections of the antenna, with other geometrical shapes.

### DESCRIPTION OF PREFERRED EMBODIMENTS

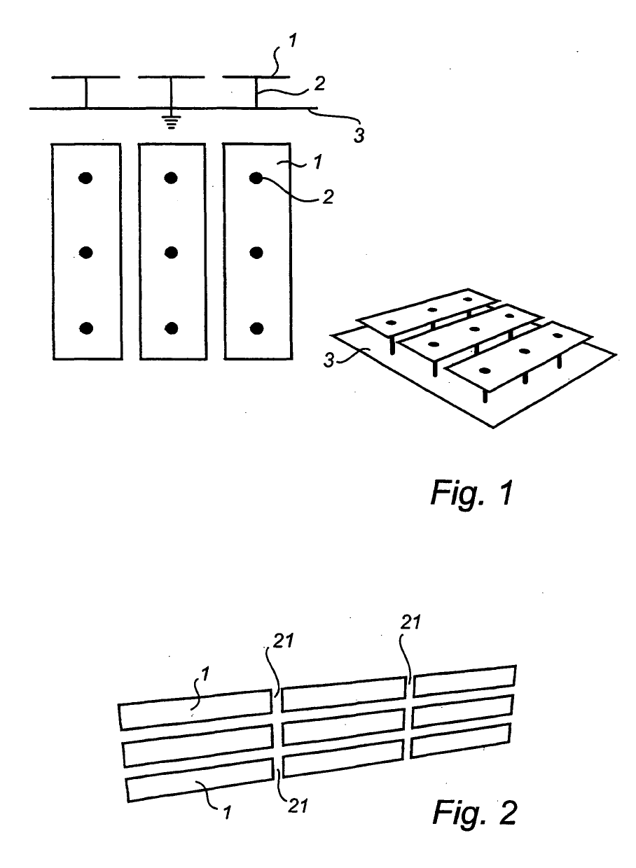

FIG. 1 shows a realization of metal strips 1 with metal pins 2. The metal pins provide contact between the strips and the ground plane 3, and functions as restraining elements for prohibiting certain types of waves. The strips could be supported by the pins, in which case there is no dielectric substrate between the strips and the ground plane. Normally, however, the strips are supported by a dielectric substrate, which has a metal sheet on the opposite side. In such a case the metal pins may be so called via holes. Via holes are often used when designing printed circuit boards, to provide metal contacts between conducting parts in different layers. The metal pins or via holes are made according to the invention.

FIG. 2 shows metal strips 1, which are broken at certain places, so that they look more like rectangular patches, and with slits or grooves 21 formed there between. The broken parts are shaped according to the invention. Accordingly, in this embodiment the restraining elements are formed by the slits 21.

FIG. 3 shows an alternative strip arrangement to be arranged on a substrate as discussed above. In this embodiment, the restraining elements are formed by parts 22 of the strips having greater dimensions in the width direction than the rest of the strips, and thus protruding in the width direction. The restraining elements could preferably be displaced in the different strip lines, e.g. in a staggered fashion.

FIG. 4 shows an alternative strip arrangement to be arranged on a substrate as discussed above. In this embodiment, the restraining elements are formed by parts 23 of the strips having decreased dimensions in the width direction than the rest of the strips, and thus being indented in the width direction.

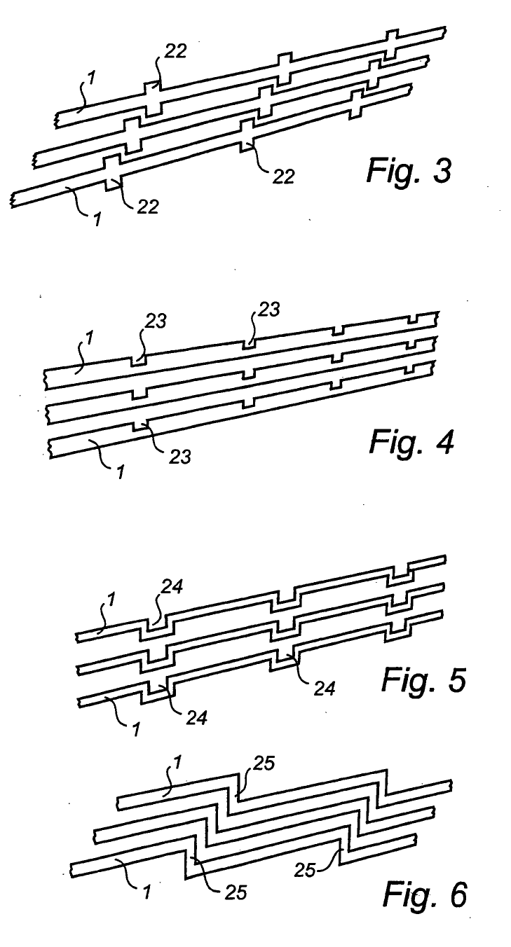

FIG. 5 shows another alternative strip arrangement to be arranged on a substrate as discussed above. In this embodiment, the restraining elements are formed by curved parts 24 of the strips being essentially U- or V-shaped, thereby displacing said part of the strips in the width direction.

FIG. 6 shows a similar alternative strip arrangement to be arranged on a substrate as discussed above. In this embodiment, the restraining elements are formed by curved parts 25 of the strips forming a stepwise displacement of the strips in the transversal direction. The restraining elements could preferably be displaced in the different strip lines in order to enable an adequate filling of the surface.

Different types of restraining elements have now been discussed. However, it should be appreciated by someone skilled in the art that many other alternatives are feasible as well.

In all the FIGS. 1-6 the strips are illustrated as being arranged along essentially parallel and straight lines. However, the invention is not limited to this case. On the contrary, the strips may very well be arranged on curved lines, as will be discussed in more detail in the following.

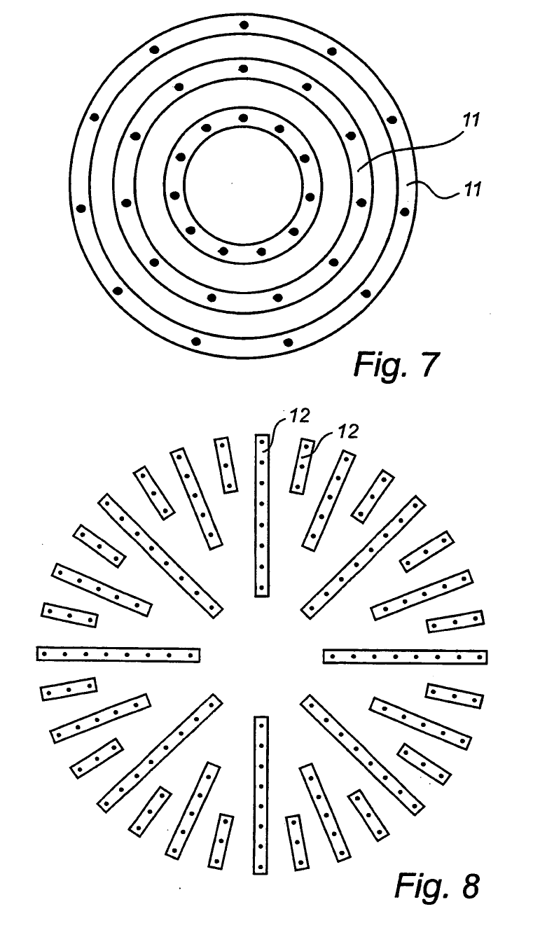

In FIG. 7 an alternative strip arrangement is illustrated to be arranged on a substrate as discussed above. In this embodiment, the strips are arranged in lines 11 forming closed loops. In this embodiment the lines forms essentially concentric circles.

In FIG. 8 another alternative strip arrangement is illustrated to be arranged on a substrate as discussed above. In this embodiment, the strips are arranged in non-parallel lines 12 arranged radially outwards from a common center point in a fan-like fashion. The lines are preferably of different lengths and/or width in order to provide a good surface filling.

In all the FIGS. 1-8 the strips are illustrated as being arranged in one plane and on a plane surface. However, the invention is not limited to this case. On the contrary, the strips may very well be arranged on curved surfaces or surfaces arranged in an angle, as will be discussed in more detail in the following.

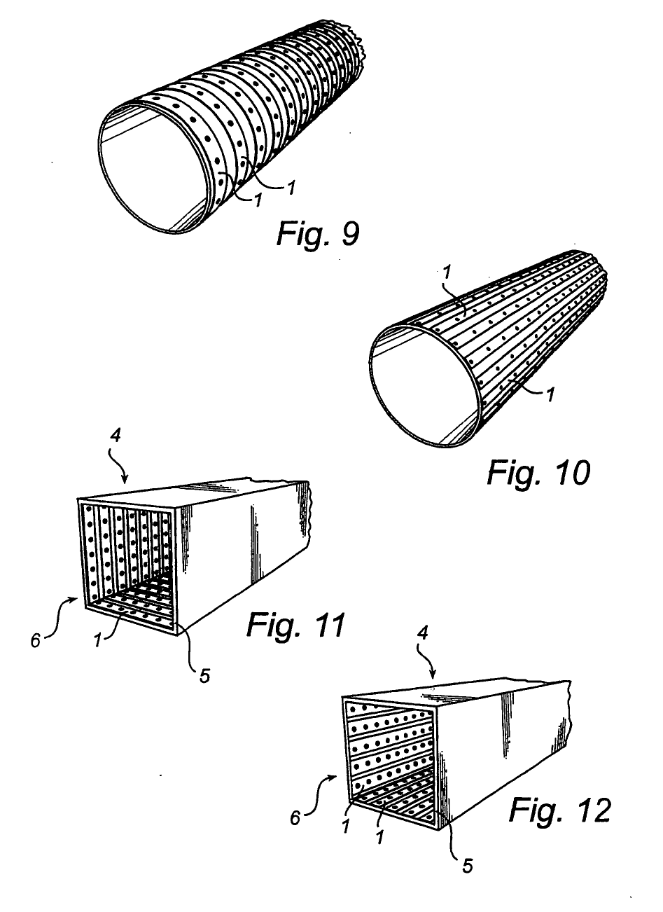

In FIG. 9 a strip arrangement is illustrated, where the strips are arranged on a curved, and in this case essentially cylindrical surface. The strips are in this embodiment arranged essentially in a transversal direction forming closed loops.

In FIG. 10 an alternative strip arrangement on a similar surface is illustrated. In this embodiment the strips 1 are arranged in a longitudinal, i.e. axial, direction.

The above discussed curved surfaces are only examples. Strip arrangements according to the invention may be provided on many different type of curved surfaces or surfaces arranged in angles.

In FIG. 11 a waveguide 4 is illustrated, comprising a dielectric substrate 5 being arranged to enclose an inner volume 6, said inner volume forming a waveguiding channel. In this embodiment the dielectric substrate forms a tube with an essentially rectangular crosssection. The strips are arranged on the inner walls, and in this embodiment essentially in a transversal direction forming closed loops. An antenna may have a similar construction, but in that case, the strips 1 are preferably arranged on the outside wall instead, as is discussed in more details in the following.

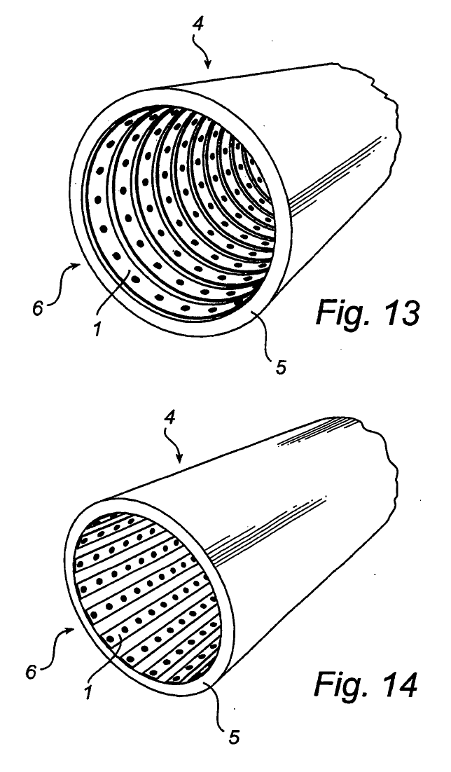

In FIG. 12 a similar waveguide 4 is illustrated, but in this embodiment the strips 1 are arranged in a longitudinal, i.e. axial, direction.

In FIGS. 13 and 14 similar waveguide constructions are illustrated for cylindrical waveguides with essentially circular cross-sections.

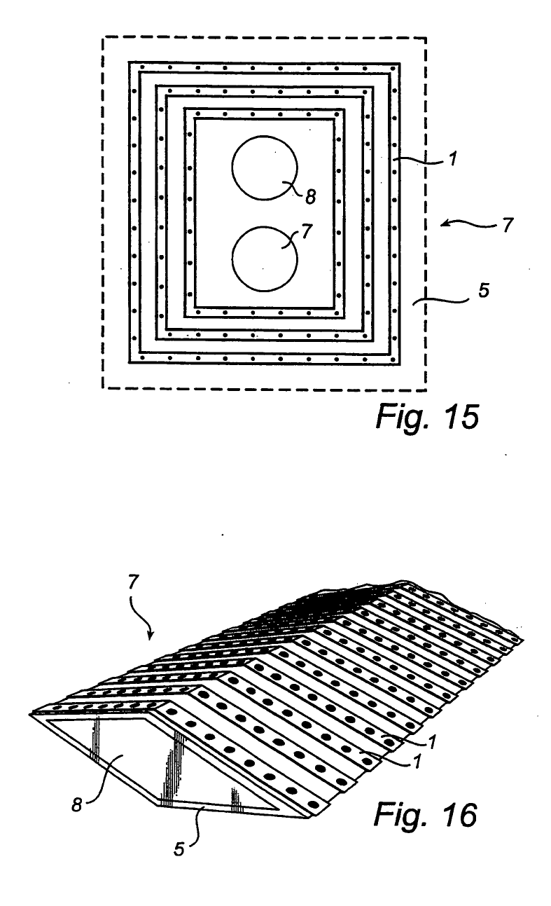

In FIG. 15 an antenna 7 is illustrated, comprising a essentially flat dielectric substrate 5, where strips are arranged in closed loops on one of the sides of said substrate. In this embodiment, the strip lines 1 form concentric rectangles around a central region containing antenna elements 8.

In FIG. 16 an alternative embodiment is illustrated. In this embodiment the dielectric substrate is arranged to enclose an inner volume, and with outer surfaces defining an essentially rhombic or diamond-shaped cross-section. The antenna element 8 is in this embodiment arranged in the inner volume formed by the dielectric substrate. Preferably, the antenna element fills the entire inner volume. The strips 1 are arranged on the outer walls, and in this embodiment essentially in a transversal direction forming closed loops.

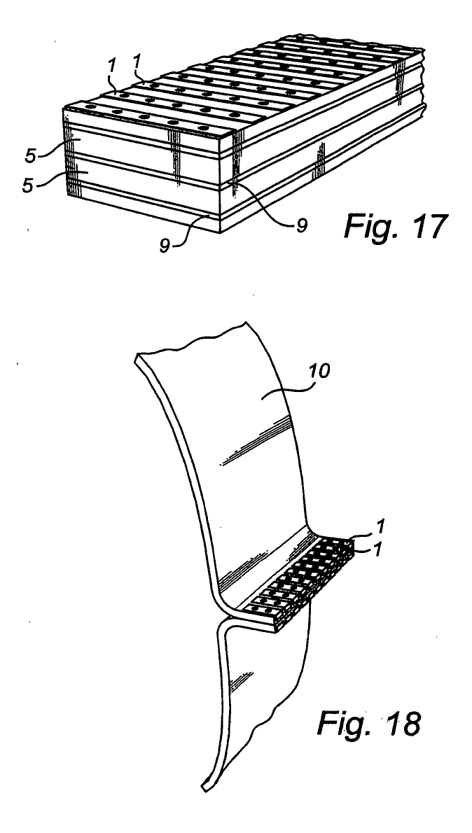

In FIG. 17 still another alternative embodiment is illustrated. In this embodiment several dielectric substrates are arranged on top of each other in a sandwich construction, and with e.g. metal plates or films arranged there between. Strips 1 could in this embodiment be arranged on the top and/or the bottom wall of the sandwich construction.

As would be appreciated by someone skilled in the art, the invention is not limited to the above-discussed geometries. On the contrary, the strip surface discussed above could be used in essentially any antenna or microwave device to improve performance. With microwaves in this application we mean also millimeter waves and even other frequency ranges, as we use the term to describe a design technique rather than the frequency range. Some examples of what kind of improvements that can be obtained are described below:
Typically, the strips in FIGS. 7 and 15 are used to reduce sidelobes from antennas located on ground planes.
Typically, the radial strips in FIG. 8 is used to enhance radiation along the ground plane.
Typically, the circular strips in FIG. 9 is used to stop radiation along the cylinder, or to enhance radiation around the cylinder.
Typically, the strips in FIG. 10 are used to enhance radiation along the cylinder, or to prohibit radiation transverse to the cylinder.
Typically, the strips in FIGS. 11 and 13 are used to create a field distribution inside the waveguide or in the aperture of the horn that is tapered to zero at the walls in all planes.
Typically, the strips in FIGS. 12 and 14 are used to obtain a uniform field distribution inside the waveguide.
Typically, the strips in FIGS. 15 and 16 are used to reduce forward scattering (i.e. blockage) from the cylinder due to waves passing the cylinder.

The invention has now been described by way of examples. However, many further alternatives and modifications are possible. In all FIGS. 7-17 the invention is shown as metal pins or via holes, but any other realization of the invention as discussed above, e.g. with reference to FIGS. 1-6, can be used. Accordingly, the term restraining element should, in the context of this application, be interpreted broadly as to include any structure or means able to prohibit propagation of certain types of waves.

Further, most figures show only three parallel strips, but naturally it can be any number of strips from 1 to infinity.

Still further, the application in FIGS. 16-17 are adapted to reduce the blockage caused by an incident wave transverse to the cylinder. The cylinder may e.g. be used as a support strut in a reflector antenna, to reduce sidelobes. The strips are shown to be transverse to the cylinder, but each strip can also be located in a plane which makes an angle different from 90 deg with respect to the cylinder axis.

The cylinder in FIG. 17 has a dielectric core, with metal plates to form the ground plane below the strips. The opposite side of the cylinder facing downwards in the figure can also be provided with strips. There may also be at least one metal plate at another location inside the cylinder, as shown.

The cylinder in FIGS. 16 and 17 can also be part of another structure which is not cylindrical, such as a radome joint 10, as shown in FIG. 18. A radome is an enclosure used to protect antennas, and it is often made of several panels that are connected together by means of joints. The radome is in the present description considered to be part of the antenna, i.e. a section of the antenna, as it influences the radiation performance of the antenna. The panels are designed to be almost transparent to electromagnetic waves, and if the joints are provided with strips, they will be almost transparent as well. This is advantageous to improve the sidelobe levels.

In the case of radome joints or other uses of the cylinders in FIGS. 16 and 17, the strips may be rather short. Specifically, their lengths may be short in terms of wavelengths. In such cases, no additional periodic restraining elements need to be present, because the short length of the strips makes the short strips themselves, and the slits between them, act as restraining elements to prohibit the undesired waves from being propagated. Accordingly, in this embodiment, the strips represent when they are short parallel single pieces of the embodiment of the invention shown in FIG. 2, located side by side.

There are typically more than 2 parallel strips per wavelength. The period of the metal pins or irregularities of the strips can vary. The period may be around 0.5 wavelength in the dielectric material, but it can also be smaller or larger.

Such, and other obvious alternatives and modifications of the invention, must be considered to be within the scope of the application, as it is defined by the appended claims.

1. An antenna or a microwave device, comprising a grounded dielectric substrate and a plurality of metal strips arranged on said substrate, characterised in that it further comprises restraining elements adapted to prohibit at least one predetermined type of waves from propagating along the strips.

2. An antenna or a microwave device according to claim 1, wherein the restraining elements are adapted to prohibit at least quasi-TEM waves from propagating along the strips.

3. An antenna or a microwave device according to claim 1, wherein the restraining elements are adapted to prohibit at least surface waves from propagating in the dielectric substrate.

4. An antenna or a microwave device according to claim 1, wherein it further comprises a ground plane arranged on the side of the dielectric substrate being opposite to the strips, wherein said restraining elements are adapted to prohibit waves from propagating along the strips between the strips and the ground plane.

5. An antenna or a microwave device according to claim 1, wherein the restraining elements comprises shorting connections, such as shorting pins or via holes, between the strips and a ground plane.

6. An antenna or a microwave device claim 1, wherein the restraining elements comprises parts of the strips having dimensional deviations.

7. An antenna or a microwave device according to claim 6, wherein the dimensional deviations comprises a decreased dimension, such as indentations, recesses, cavities, cut-in portions or openings.

8. An antenna or a microwave device according to claim 6, wherein the dimensional deviations comprises an increased dimension, such as an increased width or thickness over a part of the strips.

9. An antenna or a microwave device according to claim 1, wherein the restraining elements comprises parasitic elements arranged in the vicinity of the strips.

10. An antenna or a microwave device according to claim 1, wherein the strips are arranged in essentially straight, and preferably parallel, lines.

11. An antenna or a microwave device according to claim 1, wherein the strips are arranged in lines forming closed loops, and preferably circles, and most preferably essentially concentric circles.

12. An antenna or a microwave device according to claim 1, wherein the strips are so dimensioned and so closely arranged that the strip width together with the distance between adjacent strips does not exceed a typical wavelength for which the antenna or microwave device is designed, and preferably not exceeding a typical half wavelength, and most preferably is significantly smaller than half the wavelength.

13. An antenna or a microwave device according to claim 1, wherein the distance between restraining elements on each strip does not exceed a typical guide wavelength of the prohibited wave at the frequency for which the antenna or microwave device is designed, and preferably is about half the wavelength.

14. An antenna according to claim 1, comprising an essentially plane dielectric substrate, said strips being arranged on one side of said substrate.

15. An antenna according to claim 14, wherein the strips are arranged to encircle a central region, said central region being provided with antenna elements.

16. An antenna according to claim 1, comprising a dielectric substrate forming a core, wherein said strips are arranged to at least partly enclose said substrate.

17. A microwave device according to claim 1, comprising a dielectric substrate forming an inner waveguiding volume, wherein said strips are arranged on the inner walls facing said inner waveguiding volume.

18. A microwave device according to claim 17, wherein said strips are arranged in lines essentially following the axial direction of the waveguiding volume.

19. A microwave device according to claim 17, wherein said strips are arranged in lines essentially transversal to the axial direction of the waveguiding volume.

20. A microwave device according to claim 1, wherein the metal strips and restraining elements are directly connected.

21. A microwave device according to claim 20, wherein the restraining elements are connected to central areas of the metal strips.

22. A microwave device according to claim 20, wherein the restraining elements are connected to peripheral areas of the metal strips.

23. A microwave device according to claim 1, comprising dielectric substrates arranged in at least two separate layers and metal strips arranged in at least two separate layers, wherein at least one of said metal strip layers is arranged in between the dielectric substrate layers, and wherein the restraining elements are adapted to prohibit at least one predetermined type of waves from propagating along at least one of the metal strip layers.
